(19) United States
(12) Patent Application Publication
(10) Pub. No.: US 2014/0169614 A1
(43) Pub. Date: Jun. 19, 2014

(54) MINIATURE SUSPENSION MEMBER

(71) Applicant: Morten Kjeldsen Andersen, Odder (DK)

(72) Inventor: Morten Kjeldsen Andersen, Odder (DK)

(73) Assignee: Gettop Europe R&D ApS, Horsens (DK)

(21) Appl. No.: 14/127,087

(22) PCT Filed: Jun. 19, 2012
(86) PCT No.: PCT/EP2012/061676

§ 371 Date: Dec. 17, 2013

Related U.S. Application Data
(60) Provisional application No. 61/498,927, filed on Jun. 20, 2011.

(30) Foreign Application Priority Data
Jun. 20, 2011 (DK) PA 2011 70315

(51) Int. Cl. H04R 1/00; B06B 1/10

(52) U.S. Cl. CPC H04R 1/00; B06B 1/10
USPC 381/398; 181/172

(57) ABSTRACT

The present invention relates to a miniature suspension member for a miniature transducer, said miniature suspension member comprising first and second portions being connected by a flexible member at respective outer regions facing away from a centre of the suspension member, wherein the first portion, the second portion and the flexible member form, in combination, a polymer-based one-piece injection mouldable structure.

### FIELD OF THE INVENTION

The present invention relates to a miniature suspension member that increases the active area of a piston attached thereto. The increased active piston area increases the transducer sensitivity accordingly.

### BACKGROUND OF THE INVENTION

The active piston area of a traditional diaphragm is limited by the suspension member surrounding the piston in that the suspension member is normally positioned between the piston and a frame of the transducer.

An example of another type of transducer arrangement is provided in US 2010/0172537. Referring to FIG. 1 of US 2010/0172537 a transducer applying a plane diaphragm 110 attached to a US-shaped suspension member 120 is shown. The U-shaped suspension member 120 is tilted 90 degrees relative to the majority of transducer arrangements in order to hide the suspension member 120 below the diaphragm 110. Thus, the outer diameter of the arrangement suggested in US 2010/0172537 equals the outer physical diameter of the diaphragm.

However, the performance of the arrangement suggested in US 2010/0172537 is limited due to the orientation of the suspension member 120. The reason for this being that sound pressure generated in front of the diaphragm 110 enters the opening of the U-shaped suspension member 120 and thereby causes an acoustical short-circuiting of the transducer. This acoustical short-circuiting reduces the active area of the diaphragm 110 significantly.

It may be seen as an object of embodiments of the present invention to provide a suspension member and a diaphragm utilizing said suspension member in order to generate an increased maximum sound pressure level.

### DESCRIPTION OF THE INVENTION

The above-mentioned object is complied with by providing, in a first aspect, a miniature suspension member for a miniature transducer, said miniature suspension member comprising
a first portion adapted to be attached to a substantially plane piston element,
a second portion adapted to be attached to a portion of an associated transducer, and
a flexible member connecting the first and second portions at respective outer regions facing away from a centre of the suspension member

wherein the first portion, the second portion and the flexible member form, in combination, a polymer-based one-piece injection mouldable structure.

The shape of the suspension member of the present invention gives it a so-called negative release angle. The term negative release angle is here to be understood as a structure having a negative pull angle when it is to be released from a moulding tool. Thus, in order to release structures having negative release angles from a moulding tool the flexibility of the structure (here a suspension member) is utilized in order to release the suspension member from the mould.

It is an advantage of the suspension member according to the present invention that the active area of the piston element may be increased to what typically corresponds to 4 dB without changing the outer dimensions the transducer. A 4 dB increase in active piston area corresponds to a 2 dB increase in the achievable maximum sound pressure level.

Moreover, acoustical properties, such as total harmonic distortion (THD) and R&B level, are not negatively affected when a traditional suspension member is replaced by the suspension member according to the present invention because the displacement (stroke of the membrane) is not increased compared to a traditional suspension.

By applying the suspension member of the present invention the piston area of a standard transducer (11 mm×15 mm) from the inventors may be increased from 101 mm² to 165 mm² without changing the outer dimensions of the standard transducer. It should be noted that the suspension member of the present invention is applicable to other piston areas as well.

The respective outer regions of the first and second portions will face the outer boundary of a piston element when such piston element is attached to the suspension member. Thus, the flexible member is arranged away from a centre of the suspension member. This configuration of the suspension member is advantageous since it significantly limits the effect of acoustic short-circuiting.

The suspension member may be made of silicone. It should be noted however that materials other than silicone may be applicable as well.

The first portion may be implemented as a structure having a substantially plane surface having a through-going opening. The substantially plane surface is intended for easy mounting of the piston element which may be glued, bonded, welded etc. to the first portion of the suspension member.

The second portion may comprise a sealing structure being adapted to engage a reciprocally shaped recess in the associated transducer. The sealing structure may, in a cross-sectional profile, take a substantially circular, an elliptical, a trapezoidal or a rectangular shape. The sealing structure may form an integral part of the polymer-based one-piece injection mouldable structure.

The reciprocally-shaped recess may form part of any structure of the transducer, such as for example a frame structure or a front cover. The shape of the recess may match the shape of the sealing structure of the suspension so that said second portion is kept in position by compression forces between the recess and the sealing member.

The flexible member may, in a cross-sectional profile, comprise a circular arc structure, such as an approximately 180 degree circular arc structure.

In a second aspect, the present invention relates to a miniature diaphragm comprising a substantially plane piston element and a suspension member attached thereto, the suspension member comprising
a first portion attached to the substantially plane piston element,
a second portion adapted to be attached to a portion of an associated transducer, and
a flexible member connecting the first and second portions at respective outer regions facing away from a centre of the suspension member

wherein the first portion, the second portion and the flexible member form, in combination, a polymer-based one-piece injection mouldable structure.

The suspension member of the miniature diaphragm is preferably implemented as disclosed in connection with the first aspect. Thus, the flexible member is preferably arranged with its flexible member at or near the outer boundary of the piston element.

The piston element may comprise a plate of silicate minerals, such as MICA. The polymer-based one-piece injection mouldable structure may be made of silicone or a similar material.

In a third aspect, the present invention relates to a miniature transducer comprising a miniature diaphragm according to the second aspect.

### BRIEF DESCRIPTION OF THE DRAWINGS

The present invention will now be explained in further details with reference to the accompanying figures, where

FIG. 1 shows a comparison between an increased piston area and a traditional piston area,

FIG. 2 shows a suspension member according to the present invention,

FIG. 3 shows a cross-sectional close-up of a suspension member according to the present invention,

FIG. 4 shows a first transducer embodiment, and

FIG. 5 shows a second transducer embodiment.

While the invention is susceptible to various modifications and alternative forms, specific embodiments have been shown by way of examples in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE INVENTION

In general the present invention aims at increasing the sensitivity of miniature transducers without increasing the outer dimensions of the same. This is achieved by applying a suspension member having a negative release angle.

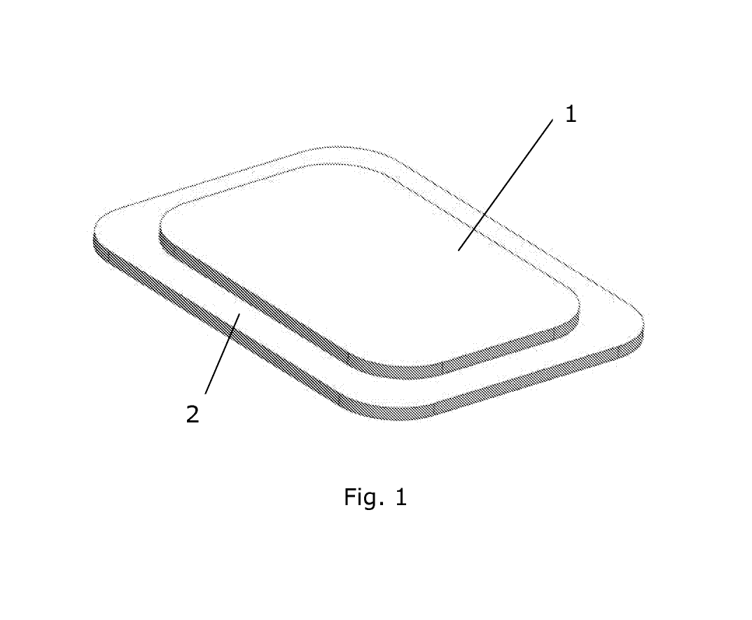

A comparison between active piston areas of a traditional diaphragm and a diaphragm applying the suspension member according to the present invention is depicted in FIG. 1. The active piston area of a traditional diaphragm is marked by reference numeral 1 in FIG. 1. If a diaphragm applies the suspension member according to the present invention the whole piston area (including areas 1 and 2) of FIG. 1 becomes active.

Piston area 2 typically increases the total piston area by an area corresponding to 4 dB for typical sized miniature transducers (11 mm×15 mm) for portable devices, such as cell phones. This corresponds to an increased acoustical sensitivity of 2 dB. Thus, by applying the suspension member of the present invention an increased acoustical sensitivity of 2 dB may be gained without increasing the outer dimensions of a transducer.

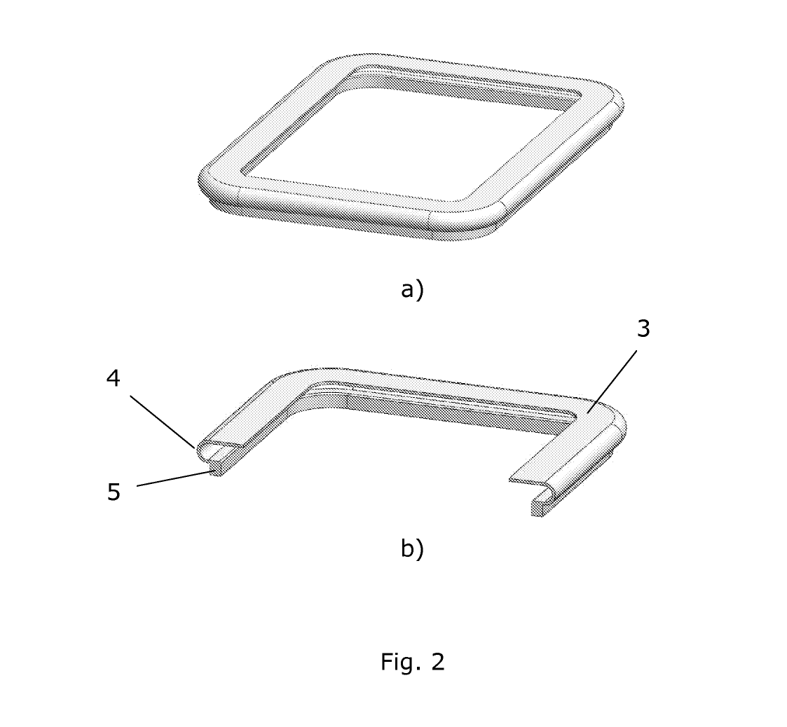

Referring now to FIG. 2 an embodiment of the present invention is depicted. FIG. 2a shows a three-dimensional depiction of a suspension member, whereas FIG. 2b shows a cross-sectional view of the same suspension member.

As depicted in FIG. 2 the suspension member comprises a substantially plane portion 3 adapted to be attached to a piston element (not shown). The suspension member further comprises a flexible portion 4 and a base portion 5 adapted to be secured to a fixed portion of an associated transducer (not shown). The base portion 5 comprises an integrated sealing structure which is adapted to engage with a corresponding recess formed in an associated transducer, such as a transducer frame (not shown).

The flexible portion 4 facilitates that the substantially plane portion 3 and the base portion 5 are moveable relative to each other. As shown, the flexible portion 4 is arranged away from a virtual centre of the suspension member.

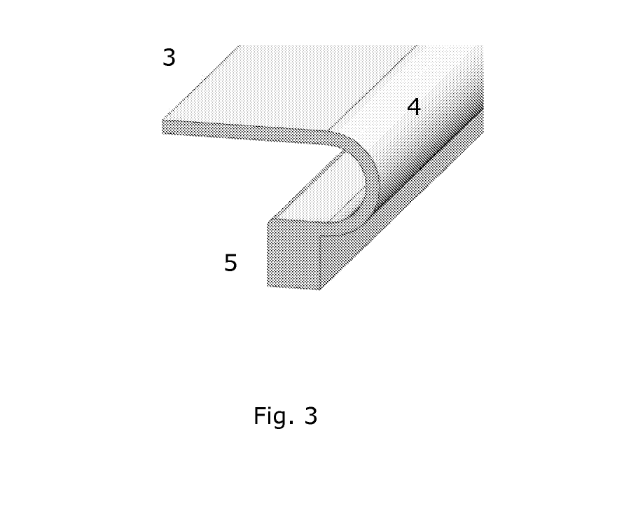

FIG. 3 shows a close-up of the cross-sectional profile of the suspension member. The sealing structure of the base portion 5 may take various cross-sectional shapes, such as quadratic, rectangular, circular, elliptical, trapezoidal etc.. It is shaped to match a reciprocally shaped recess in the associated transducer thereby forming an acoustical sealing therewith.

Preferably, the suspension member is manufactured as a mouldable one-piece component. The material used for manufacturing the suspension member may in principle be any mouldable material, such as silicone. The flexible properties of silicone allow that suspension members having negative release angles can be released from the mould without being damaged.

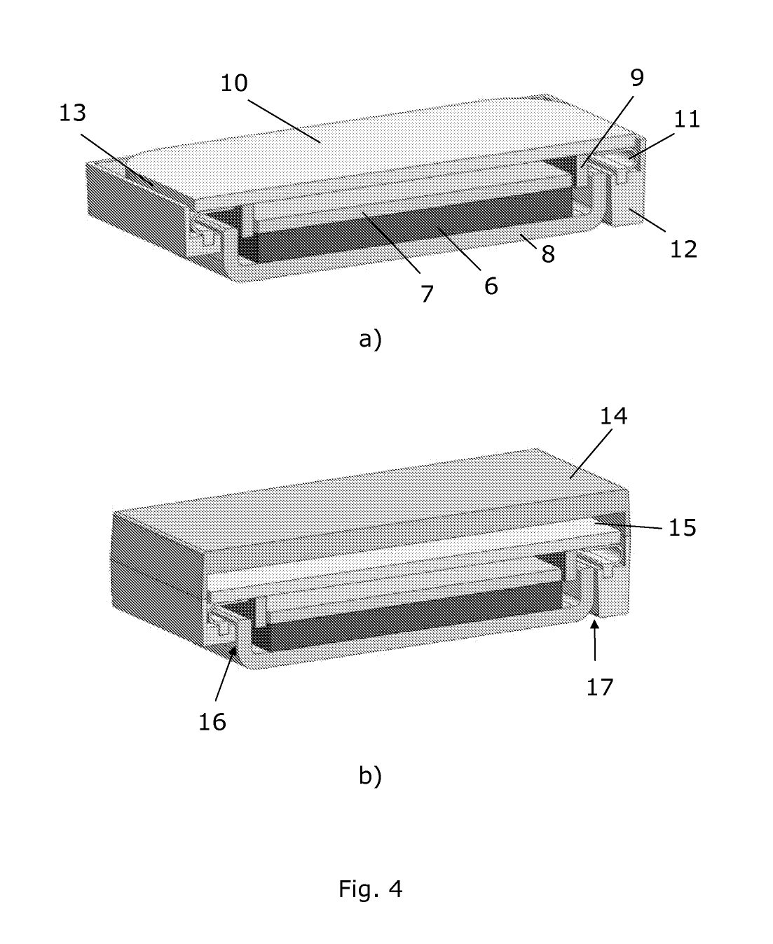

FIG. 4 shows a transducer applying the suspension member according to the present invention.

Referring now to FIG. 4a a permanent magnet 6 and a pair of pole pieces 7, 8 drive a voice coil 9 which is attached to a piston 10. The piston 10 is preferably made of MICA. The piston 10 is attached to the suspension member 11—the latter being attached to a frame structure 12 of the transducer via an appropriately shaped recess in said frame structure 12.

As depicted in FIG. 4a the suspension member 11 does not extend across the edge 13 of the piston 10. The flexible portion of the suspension member is formed as a circular arc which extends in the direction of the outer edge of the piston 10, i.e. away from a virtual centre of the suspension member. By arranging the flexible member in this manner acoustical short-circuiting of the transducer can be avoided because sound pressure generated in front of the piston is not allowed to enter a region below the piston 10.

A drive current launched into the voice coil 9 will cause movements of the piston/voice coil. In FIG. 4b a cover 14 is applied to the transducer whereby an acoustical back chamber 15 is formed between said cover 14 and the piston 10. A corresponding acoustical front chamber is formed below the piston 10 and sound pressure is allowed to escape through sound outlets 16, 17.

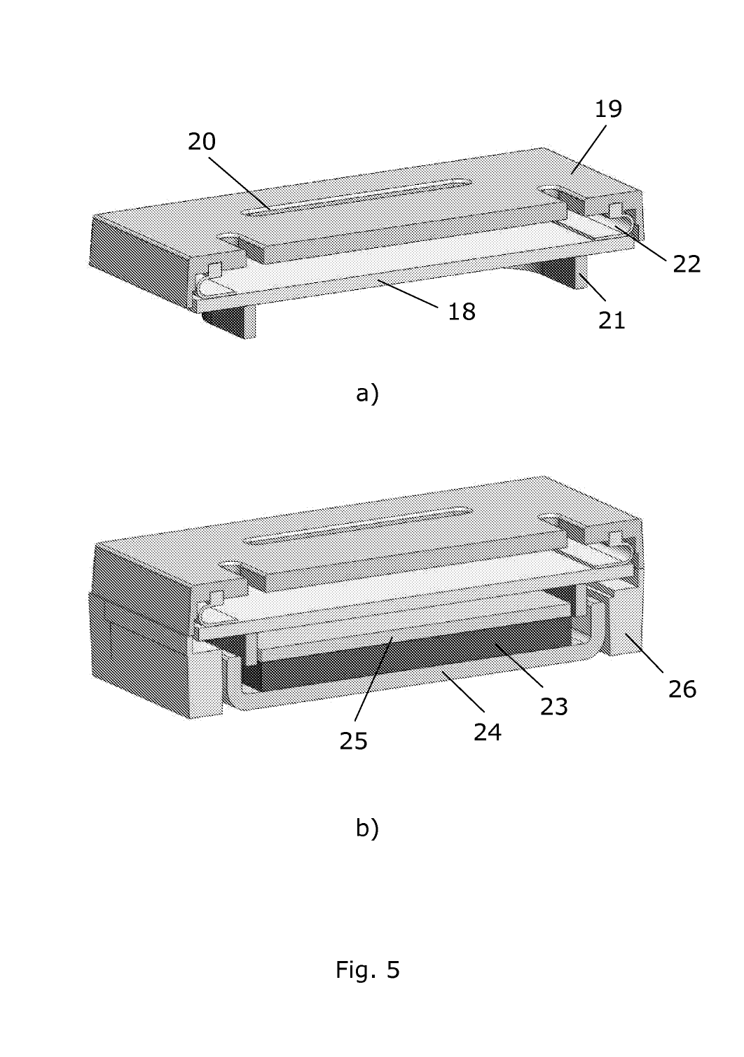

FIG. 5 shows a transducer where the piston 18 is suspended in a front cover 19 having sound outlets 20 arranged therein, cf. FIG. 5a. A voice coil 21 is secured to the piston 18 which is suspended in the suspension member 22. As depicted in FIG. 5a the suspension member 22 is secured to the piston 18 and to the front cover 19 where a recess provided in said front cover matches the shape of the sealing structure of the base portion of the suspension member, cf. FIG. 3.

A cross-sectional view of an assembled transducer is depicted in FIG. 5b. A permanent magnet 23 and a pair of pole pieces 24, 25 are provided to form a transducer motor. A shielding member 26 ensures that the back chamber is acoustically shielded in case the transducer is mounted with its pole piece 24 and shielding member 26 abutting a mounting surface.

With reference to FIGS. 3-5 the sealing structure of the suspension member may in principle take any cross-sectional shape, such as a substantially circular shape, an elliptical shape, a trapezoidal shape etc. The reciprocal recess of the associated transducer is shaped to match the shape of the sealing structure so that the suspension member can be kept in position by compression forces.

The suspension member of the present invention is in principle not limited to certain dimensions. However, the largest advantages of the present invention is associated with suspension members for miniature transducers having dimensions of typically (length×width×height) 15×10×0.5 mm.

1. A miniature suspension member for a miniature transducer, said miniature suspension member comprising
a first portion adapted to be attached to a substantially plane piston element, the first portion having a through-going opening,
a second portion adapted to be attached to a frame structure of an associated transducer, and
a flexible member connecting the first and second portions, said flexible member extending away from a centre of the suspension member in order to limit the effect of acoustic short-circuiting,
wherein the first portion, the second portion and the flexible member form, in combination, a polymer-based one-piece injection mouldable structure.

2. A miniature suspension member according to claim 1, wherein the polymer-based one-piece injection mouldable structure is made of silicone.

3. A miniature suspension member according to claim 1, wherein the second portion comprises a sealing structure being adapted to engage a reciprocally shaped recess in the associated transducer.

4. A miniature suspension member according to claim 3, wherein the sealing structure, in a cross-sectional profile, takes a substantially circular, an elliptical, a trapezoidal or a rectangular shape.

5. A miniature diaphragm comprising a substantially plane piston element and a suspension member attached thereto, the suspension member comprising
a first portion attached to the substantially plane piston element, the first portion having a through-going opening,
a second portion adapted to be attached to a frame structure of an associated transducer, and
a flexible member connecting the first and second portions, said flexible member extending away from a centre of the suspension member in order to limit the effect of acoustic short-circuiting,
wherein the first portion, the second portion and the flexible member form, in combination, a polymer-based one-piece injection mouldable structure.

6. A miniature diaphragm according to claim 5, wherein the second portion comprises a sealing structure being adapted to engage a reciprocally shaped recess in the associated transducer.

7. A miniature diaphragm according to claim 6, wherein the sealing structure, in a cross-sectional profile, takes a substantially circular, an elliptical, a trapezoidal or a rectangular shape.

8. A miniature diaphragm according to claim 5, wherein the piston element comprises a plate of silicate minerals.

9. A miniature diaphragm according to claim 5, wherein the polymer-based one-piece injection mouldable structure is made of silicone.

10. A miniature transducer comprising a miniature diaphragm according to claim 5.

11. A miniature suspension member according to claim 2, wherein the second portion comprises a sealing structure being adapted to engage a reciprocally shaped recess in the associated transducer.

12. A miniature diaphragm according to claim 6, wherein the piston element comprises a plate of silicate minerals.

13. A miniature diaphragm according to claim 7, wherein the piston element comprises a plate of silicate minerals.

14. A miniature diaphragm according to claim 6, wherein the polymer-based one-piece injection mouldable structure is made of silicone.

15. A miniature diaphragm according to claim 7, wherein the polymer-based one-piece injection mouldable structure is made of silicone.

16. A miniature diaphragm according to claim 8, wherein the polymer-based one-piece injection mouldable structure is made of silicone.

17. A miniature transducer according to claim 10, wherein the second portion comprises a sealing structure being adapted to engage a reciprocally shaped recess in the associated transducer.

18. A miniature transducer according to claim 10, wherein the sealing structure, in a cross-sectional profile, takes a substantially circular, an elliptical, a trapezoidal or a rectangular shape.

19. A miniature transducer according to claim 10, wherein the piston element comprises a plate of silicate minerals.

20. A miniature transducer according to claim 10, wherein the polymer-based one-piece injection mouldable structure is made of silicone.
